(19) United States
(12) Patent Application Publication
(10) Pub. No.: US 2017/0330204 A1
(43) Pub. Date: Nov. 16, 2017

(54) WEB SERVER EVALUATION AND IMPROVEMENT SYSTEM

(71) Applicant: Target Brands, Inc., Minneapolis, MN (US)

(72) Inventors: Christopher Edward Johnson, Plymouth, MN (US); Russell Roy Sanborn, St. Paul, MN (US); Dakota Reese Brown, St. Paul, MN (US)

(21) Appl. No.: 15/151,024

(22) Filed: May 10, 2016

(51) Int. Cl. G06Q 30/02; G06F 17/30; G06F 3/0484

(52) U.S. Cl. CPC G06Q 30/0201; G06F 17/30876; G06F 17/30867; G06F 3/04847; G06F 17/3053; G06F 17/30554

(57) ABSTRACT

A method includes displaying a user interface that includes a date range control and a term input area. A date range is received through the date range control and a term is received through the term input area. Metrics for all search phrases that were submitted to a web site during the date range and that included the term are retrieved. The retrieved metrics are displayed such that retrieved metrics for a plurality of search phrases are shown together.

### BACKGROUND

On the Internet, retailers provide websites to allow customers to search for and purchase products. A retailer's website is composed of a plurality of webpages that are related to each other through a site map or site taxonomy. Thus, customers are able to traverse between webpages that form the website according to the structure described by the site map/site taxonomy.

When a customer first visits a website, the web server starts a session for the customer. While the session is active, the server keeps track of actions that the customer takes, such as pages that the customer visits and products that the customer places in their shopping cart. When there is a period of inactivity, the session expires and is closed by the web server.

The discussion above is merely provided for general background information and is not intended to be used as an aid in determining the scope of the claimed subject matter. The claimed subject matter is not limited to implementations that solve any or all disadvantages noted in the background.

### SUMMARY

A computer-implemented method includes receiving, by a server, a term and searching a database to identify consumer searches of a website that included the term. For each identified consumer search, metrics related to visits to the website during which the consumer search was submitted are retrieved where the metrics include metrics related to purchases. A user interface is displayed showing the metrics for the identified consumer searches. A rule definition is then received for one of the identified consumer searches, the rule definition indicating a web page that is to be returned. The rule definition is linked to the identified consumer search in a search rules database used by a web server that serves the website such that when the consumer search is submitted the web page is returned.

A method includes displaying a user interface that includes a date range control and a term input area. A date range is received through the date range control and a term is received through the term input area. Metrics for all search phrases that were submitted to a web site during the date range and that included the term are retrieved. The retrieved metrics are displayed such that retrieved metrics for a plurality of search phrases are shown together.

A server includes a memory and a processor. The memory stores actual search phrases submitted to a retail web site by customers, and for each actual search phrase, a value for at least one web site session metric. The processor executes processes to receive a term through a user interface and search the memory to identify all actual search phrases that include the term. For each identified actual search phrase, a value for the at least one session metric for the actual search phrase is retrieved. A user interface is generated that includes each identified actual search phrase and the value for the at least one session metric for each identified actual search phrase such that the values for the at least one session metric for two separate identified actual search phrases are displayed at the same time.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a flow diagram of a method in accordance with one embodiment.

FIG. 2 is a block diagram of elements used in the method of FIG. 1.

FIG. 3 is an example user interface for receiving a search term and date range.

FIG. 4 is an example user interface showing metrics for a search term.

FIG. 5 is an example user interface showing metrics for search phrases that include the search term.

FIG. 6 is an example graph for the search term.

FIG. 7 provides a flow diagram for setting a rule definition for a search phrase.

FIG. 8 is a block diagram of an exemplary computing device that can be used as a server in accordance with the various embodiments.

### DETAILED DESCRIPTION

Many retail websites include search boxes that allow customers to enter words and phrases for items that they are looking to purchase. Because customers are not always sure of the exact wording that describes the products they are interested in purchasing, their searches can include words and phrases that do not correspond exactly to the actual products for sale on the website. Predicting what words and phrases customers will use with 100% accuracy is impossible. As a result, developing a website that will direct consumers to the correct page so that the consumer can purchase the products they are looking for is extremely difficult. In addition, it has not been possible to identify customer search terms that are most often used but that fail to result in a sale on the merchant site. Without such information, it is impossible to improve the operation of the web server so that it provides the necessary information for customers to find and purchase what they want.

In the embodiments described below, a method and server are provided that allow a web server to be improved by identifying actual search phrases that use a core term and retrieving metrics associated with each such phrase. In accordance with some embodiments, the metrics for multiple search phrases are shown together on a single user interface to show the relative popularity of the search phrases among customers as well as the relative success rates that customers have in making purchases using those search phrases.

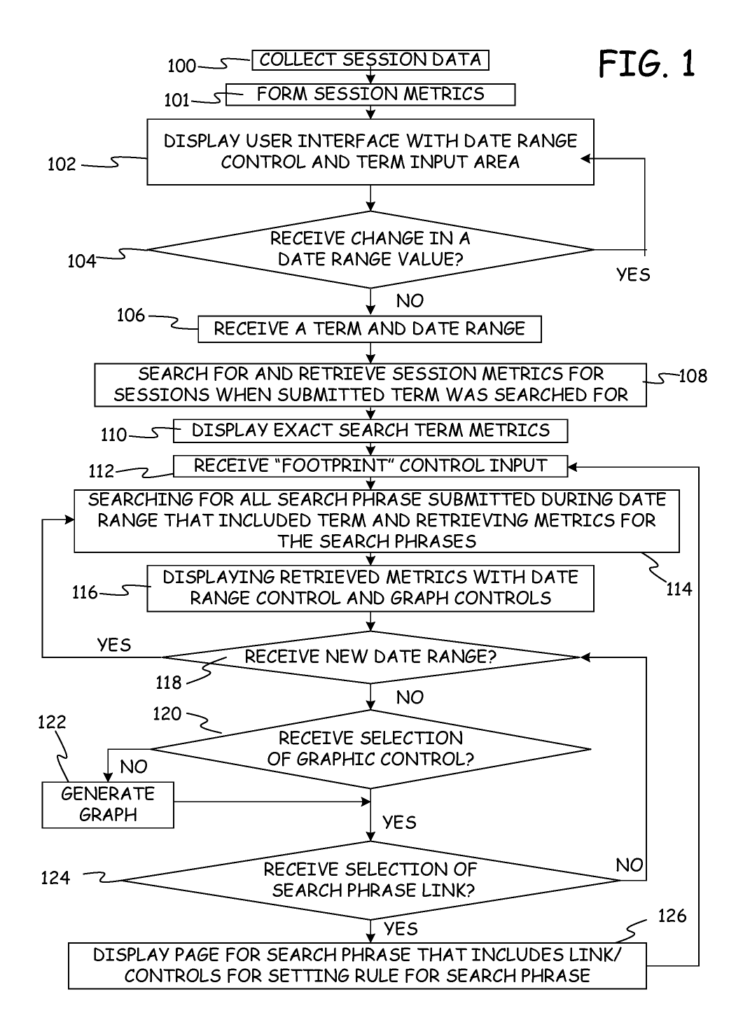

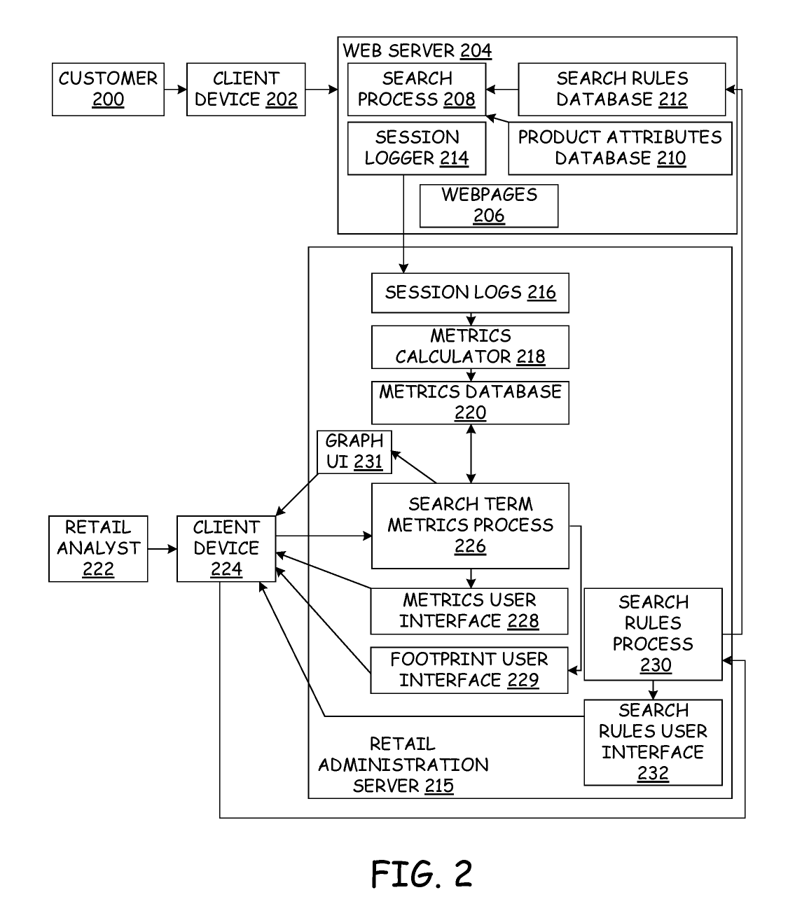

FIG. 1 provides a flow diagram and FIG. 2 provides a block diagram showing a method and system, respectively, used in various embodiments. In step 100 of FIG. 1, session data is collected by a session logger 214 of web server 204. The session is started when a customer 200 using a client device 202 accesses one of webpages 206 on web server 204. In accordance with one embodiment, session logger 214 keeps track of all events that take place while customer 200 is interacting with webpages 206 including keeping track of search terms and search phrases entered by customer 200, products placed into the shopping cart by customer 200, products purchased and the amount spent by customer 200 during the session, the last page visited by customer 200 before the session ended and the links clicked on immediately after results of a search are presented to customer 200. Session logger 214 generates a collection of session logs 216 that can be downloaded to a retail administration server 215. Session logs 216 represent stored session information for a large number of customers 200.

Search process 208 on web server 204 performs searches for web server 204 based on search terms and phrases entered by customer 200 through client device 202. Such search phrases or terms are referred to herein as consumer searches, actual searches and customer searches. In accordance with one embodiment, search process 208 first searches for the submitted term in a search rules database 212 and then in a product attributes database 210. Search rules database 212 contains rules for certain search phrases, such that when a search phrase is received, the search rule directs search process 208 to return a particular search page. The returned search page can include a page that includes multiple products matching the search phrase, or a page containing only a single product matching the search phrase. Product attributes database 210 contains attributes for each product for sale through the web server such as product name, sizes, colors, and manufacturer as well as various categories that the product falls within.

At step 101, a metrics calculator 218 of retail administration server 215 generates metrics from the session logs 216. The metrics generated by metrics calculator 218 are determined over various date ranges such as over various weeks. Thus, separate metrics would be calculated for each week of a year in accordance with one embodiment. Particular metrics formed by metrics calculator 218 are discussed further below. The metrics are stored in metrics database 220. In accordance with one embodiment, metrics calculator 218 calculates the metrics relative to search phrases that were submitted during each session. Thus, for a single week, every session that uses a particular search phrase is identified in session logs 216 and metrics are calculated for those sessions.

In step 102, a retail analyst 222 uses a client device 224 to access a search term metrics process 226 on retail administration server 215. In response, search term metrics process 226 returns a home search page that includes a date range control and a term input area.

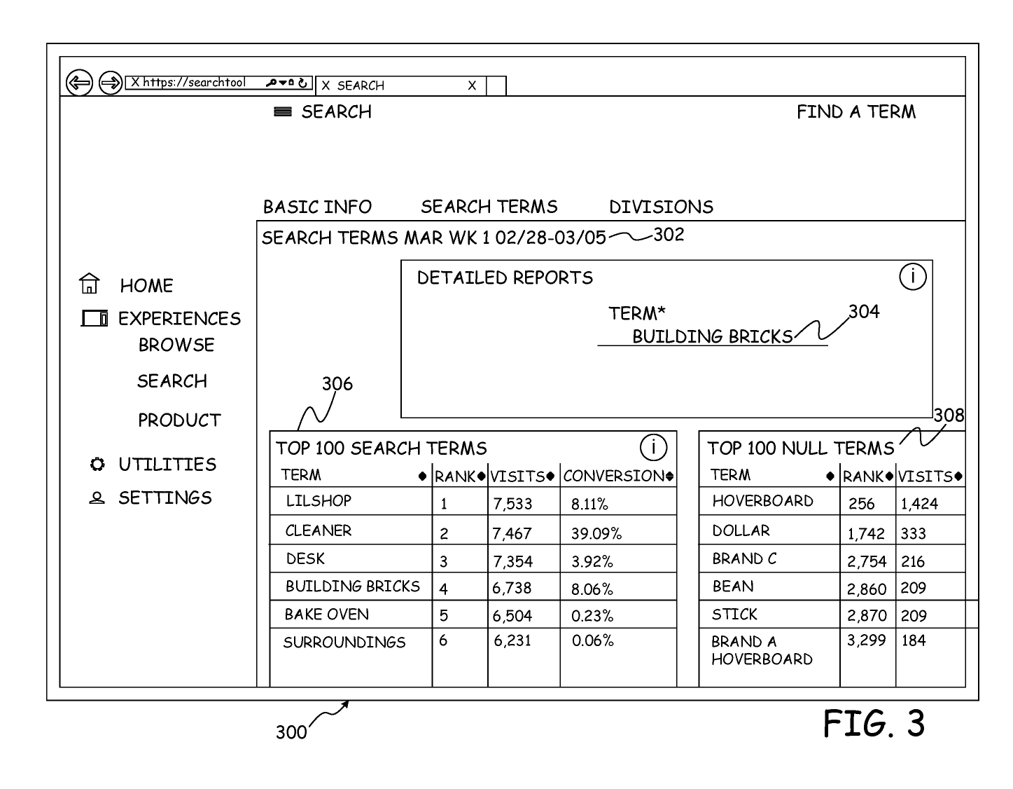

FIG. 3 provides an example of a search homepage user interface 300 returned in step 102. User interface 300 is shown as a webpage delivered within a browser. However, in other embodiments, user interface 300 may be displayed within an application specific user interface. User interface 300 includes date range control 302, term input area 304, top search terms list 306 and top null terms list 308. Top search terms list 306 ranks all search terms received by web server 204 during the date range listed in date range control 302. In accordance with one embodiment, the search terms are ranked based on the number of times they are submitted. Top null terms list 308 provides a ranked list of search terms submitted to web server 204 that were not matched by search process 208 to any one webpage 206 because the terms were not found in product attribute database 210 or in search rules database 212.

At step 104, a date range value is selected using date range control 302. In particular, by clicking on date range control 302, a list of available date ranges is displayed that can be selected by the retail analyst 222. In accordance with one embodiment, the date ranges are each one week long. In other embodiments, the user may designate the length of each date range or the date ranges may be daily, monthly, quarterly or yearly. Combinations of different length date ranges may also be provided in the list of available date ranges. When the date range is altered, search term metrics process 226 redisplays the user interface at step 102 by retrieving new values for the top 100 search terms 306 and the top 100 null terms 308 based on the newly selected date range.

At step 106, retail analyst 222 enters a term in term input area 304 and presses enter to thereby submit the date range listed in date range control 302 and the entered term so that the date range and term are received by search term metrics process 226.

At step 108, search term metrics process 226 uses the submitted term to search metrics database 220 and retrieve session metrics for all sessions in which the exact submitted term was searched for by a customer 200.

At step 110, search term metrics process 226 generates a metrics user interface 228 that is provided to client device 224.

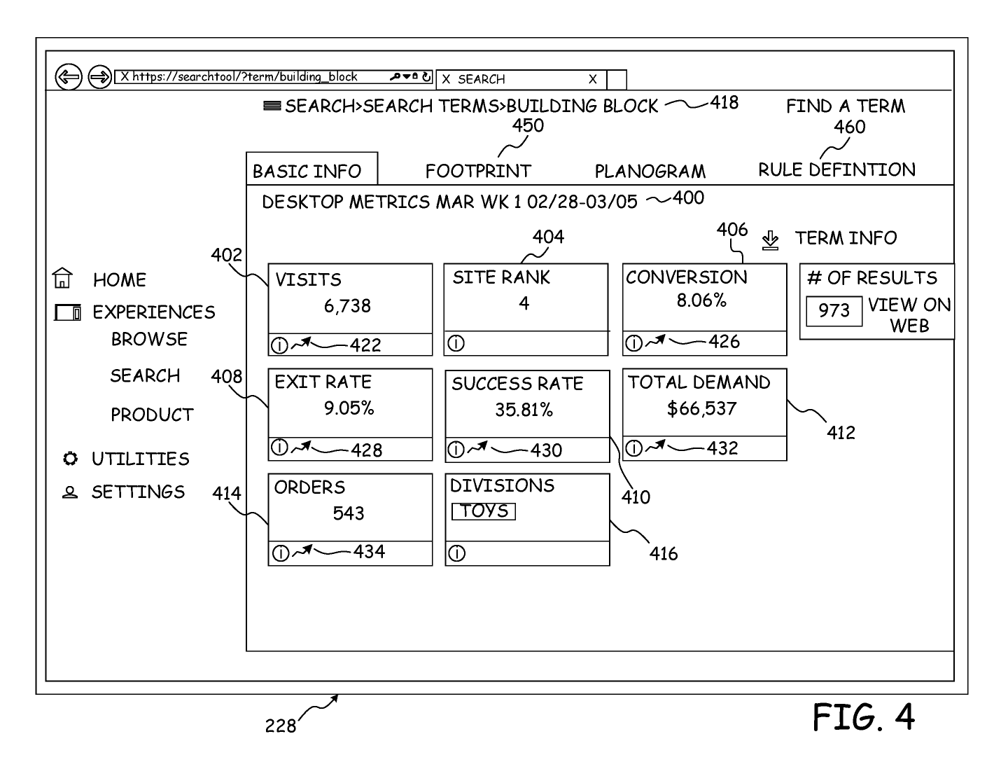

FIG. 4 provides an example of metrics user interface 228 for the search phrase “building block”. Metrics user interface 228 includes a submitted term 418, a selectable date control 400, a visits metric 402, a site rank metric 404, a conversion metric 406, an exit rate metric 408, success rate metric 410, total demand metric 412 and an orders metric 414. In addition, metrics user interface 228 includes a divisions listing 416.

Submitted term 418 is the term that the present metrics are associated with and in FIG. 4 is “building block.”

Date range control 400 indicates the date range associated with the presently displayed metrics. Retail analyst 222 can change the date range for the displayed metrics using date control 400. When the date range is changed, search term metrics process 226 performs a new search of metrics database 220 to retrieve the metrics for the newly selected date range for the submitted term 418.

Visits metric 402 is the total count of the number of sessions in which search term 418 was submitted during the date range. Site rank metric 404 indicates how the number of sessions in visits metric 402 compares to the number of sessions for other search terms. Thus, metrics user interface 228 of FIG. 4 indicates that the phrase “building block” was the fourth most often searched term during the date range set in date range 400.

Orders metric 414 indicates the total number of sessions in visits metric 402 during which an order was placed. Conversion metric 406 indicates the percentage of the sessions in visits metric 402 that resulted in an order being placed by a customer. Conversion metric 406 is equal to the ratio of orders metric 414 over visits metric 402.

Exit rate metric 408 indicates the percentage of sessions that ended after the search results for the phrase “building block” were returned. In other words, the results of the search for building block were the last pages returned to the customer before the session became inactive.

Success rate metric 410 indicates the plurality of sessions in which after receiving the search results for “building blocks”, the user clicked on a link to a product details page provided in the search results.

Total demand metric 412 is the amount of money spent through orders placed during sessions in which the search phrase “building block” was submitted.

Division list 406 lists the categories that the search term has been associated with in search rules database 212.

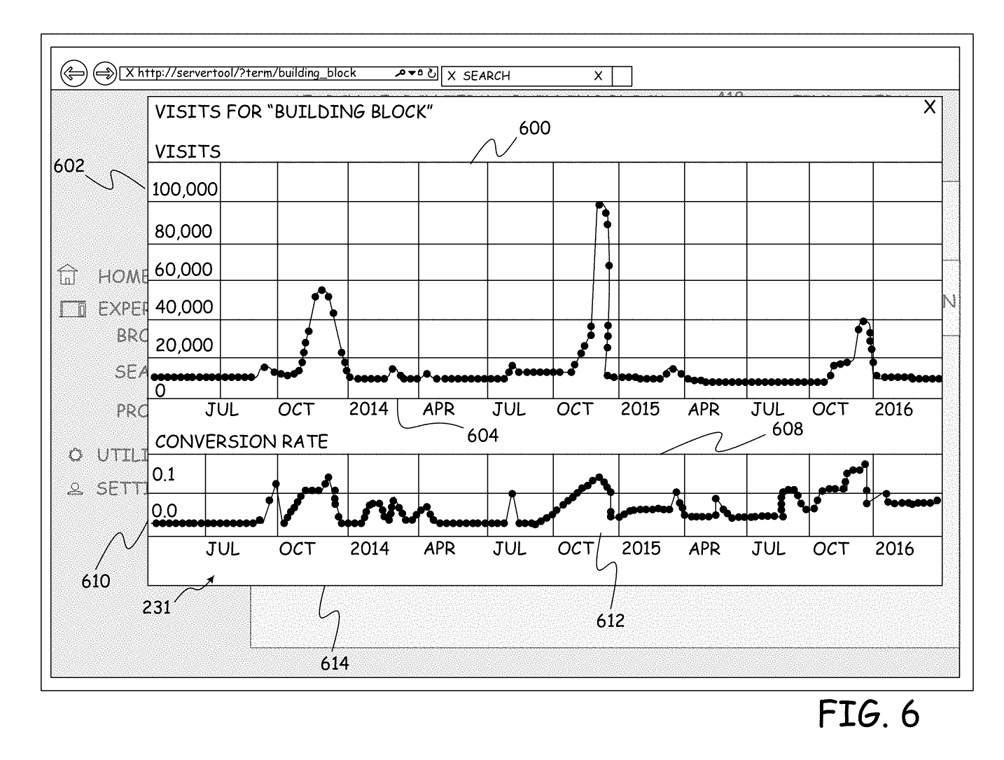

Metrics 402, 406, 408, 410, 412 and 414 each contain respective graph controls 422, 426, 428, 430, 432 and 434. When a graph control is selected, a new window is opened showing a graph of the associated metric over a period of time. The period of time can match date range 400 or can be longer than date range 400. In accordance with one embodiment, a graph shows a value for each day for the metric during the date range and includes a graph line between the values. An example of possible graphs is shown below for FIG. 6.

Metrics user interface 228 also includes a “footprint” control 450. At step 112 of FIG. 1, searching process 226 receives an indication that “footprint” control 450 was selected by retail analyst 222. Upon receiving the “footprint” control input, search term metrics process 226 performs a search of metrics database 220 for all search phrases submitted during date range 400 that included submitted term 418 either alone or with another word or phrase at step 114. The additional word or words can be before, after or both before and after submitted term 418. Search term metrics process 226 retrieves metrics for each such search phrase and at step 116 displays the retrieved metrics with a date range control and graph controls in a “footprint” user interface 229. In particular, metrics are retrieved for each individual search phrase that included the submitted term and combined metrics are provided that combine the metrics of those search phrases.

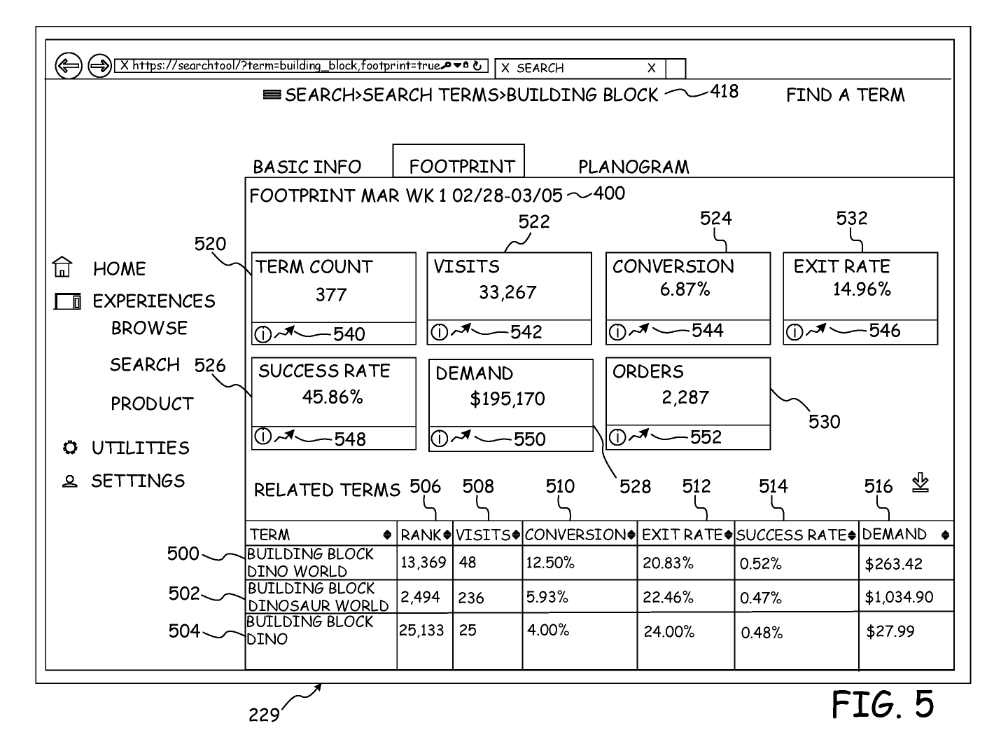

FIG. 5 provides an example of “footprint” user interface 229 showing the metrics for some of the search phrases that included submitted term 418 during date range 400. In particular, in FIG. 5, three phrases 500, 502 and 504 have been retrieved that were submitted during date range 400 and that include the phase “building block”. Each search phrase has a number of metrics displayed for it including rank metric 506, visits metric 508, conversion metric 510, exit rate metric 512, success rate metric 514 and demand metric 516. Each of these metrics is the same as described above for FIG. 4. The returned search phrases may be ordered alphabetically or by any one of the metrics either in a top/down manner or a bottom/up manner.

Footprint user interface 229 of FIG. 5 also includes combined metrics such as term count metric 520, combined visits metric 522, combined conversion metric 524, combined success rate metric 526, combined demand metric 528, combined orders metric 530 and combined exit rate metric 532. Term count metric 520 is the number of search phrases that included submitted term 418 and that were submitted during date range 400. Combined visits metric 522 is the number of sessions during which a search phrase that included term 418 was submitted during date range 400. Combined orders metric 530 is the number of sessions during which an order was placed and during which a search phrase including term 418 was submitted during date range 400. Combined conversion metric 524 is the ratio of combined orders metric 530 to combined visits metric 522. Combined success rate metric 526 is the percent of visits 522 where a customer selected a link to a products details page after receiving the search results for a phrase that included term 418 during date range 400. Combined demand metric 528 is the total value of the orders in combined orders metric 530. Combined exit rate metric 532 is the percent of combined visits metric 522 in which the page returned to the customer in response to receiving the search phase was the last page that the customer received before the session became inactive. Each of the combined metrics shown in FIG. 5 includes a graph control that will display a graph of the value of the metric on different days across a date range. The date range can be the same as date range 400 or may be larger than date range 400. The graph links include graph links 540, 542, 544, 546, 548, 550 and 552 for combined metrics 520, 522, 524, 532, 526, 528 and 530, respectively.

Date range control 400 is selectable such that retail analyst 222 can change the date range. If at step 118, retail analyst 222 changes the date range, search term metrics process 226 receives the new date range and returns to step 114 to search for all phrases submitted during the new date range that included term 418. Step 116 is then repeated displaying a new footprint user interface 229 for the new date range.

Retail analyst 222 can also select any one of the graph controls 540, 542, 544, 546, 548, 550 and 552. When retail analyst 222 selects such a graph control, the selection is received at step 120 and in response, search term metric process 226 generates a graph user interface 231 for the selected metric and returns the generated graph to client device 224.

FIG. 6 provides an example of a graph user interface 231 showing graphs for multiple combined metrics for the term “building block”. In particular, graph user interface 231 includes graph 600, which shows values for combined visits metric 522 at individual days over a three year period. In graph 600, the combined visits are shown on vertical axis 602 and dates are shown along horizontal axis 604. Graph user interface 231 also includes conversion rate metrics graph 608 that shows conversion rates on vertical axis 610 and individual days on horizontal axis 612. In the embodiment shown in FIG. 6, graph user interface 231 is shown in a window 614 displayed above footprint user interface 229.

After graph user interface 231 is generated and displayed at step 122 or if no graph control is selected at step 120, the process continues at step 124. At step 124, search term metric process 226 determines if a search phrase has been selected from FIG. 5. In accordance with one embodiment, each of search phrases 500, 502 and 504 are links that may be selected. If none of the phrases are selected, the process returns to step 118 to see if a new date range has been selected. If one of the search phrases is selected at step 124, the process continues at step 126 where search term metric process 226 generates a metrics user interface 228 for the selected phrase producing a metrics interface similar to the one shown in FIG. 4 but for the selected search phrase instead of the original term 418. The process then returns to step 112 to determine if the user had selected the footprint control input for the selected phrase.

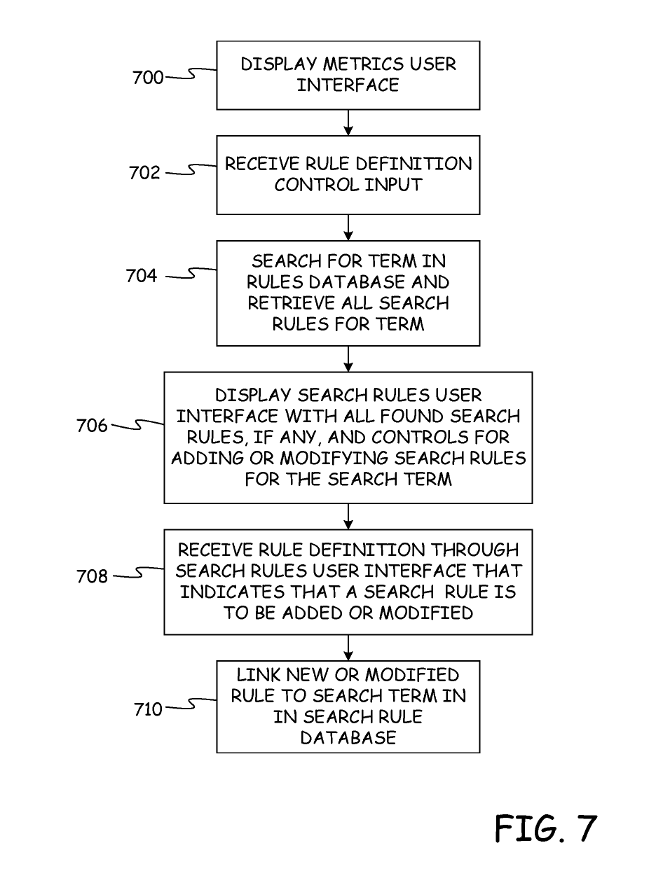

Metrics user interface 228 also includes a rule definition control 460 that can be used to set a rule definition for search term 418. FIG. 7 provides a flow diagram for a method of setting a rule definition using control 460.

In step 700, metrics user interface 228 is displayed, either as a result of a submitted search term from the search home page or from the selection of a phrase link from a “footprints” user interface such as phrase links 500, 502 and 504 of “footprints” user interface 229.

At step 702, retail analyst 222 selects rule definition control 460, which calls search rules process 230. Search rules process 230 receives the call from rule definition control 460 along with search term 418. At step 704, search rules process 230 searches search rules database 212 for search term 418 and returns any search rules stored in database 212 for search term 418. At step 706, search rules process 230 displays a search rules user interface 232 that includes the search rules found in database 212, if any, and controls for adding or modifying search rule definitions for search term 418. At step 708, search rules process 230 receives a rule definition through search rules user interface 232 that indicates that a search rule definition is to be added or modified. In accordance with one embodiment, the search rule definition identifies a web page that is to be returned when search term 418 is submitted. In response to the received search rule definition, search rule process 230 adds the new search rule definition or edits the existing search rule definition in search rules database 212 and links the new search rule definition or edited search rule definition to the search term at step 710.

Through the methods above, and in accordance with one embodiment, when the metrics are provided for a plurality of consumer searches that include a search term, one of the metrics indicates that one of the identified consumer searches results in lower purchases than other identified consumer searches. Based on this information, retail analyst 222 can provide a new rule definition for the identified consumer search that is received by search rules process 230. The new rule definition will return a web page that increases purchase.

Because “footprint” user interface 229 displays metrics for multiple search phrases that include a search term as well as combined metrics for all such search phrases, user interface 229 improves the ability of retail administration server 215 to convey the relative effectiveness of web server 204 for various phrases. Ideally, when web server 204 receives a search query, search process 208 returns a webpage that allows customer 200 to find and purchase the product they are looking for. If web server 204 is not operating ideally for a phrase, user interface 229 will quickly convey this information to retail analyst 222 by showing comparative metrics between various phrases. Further, when retail analyst 222 identifies a search phrase that is not being handled well by web server 204, rule definition control 460 and search rules user interface 232 provide a simple and direct means for retail analyst 222 to improve the operation of web server 204 by adding or modifying a search rule for the search phrase.

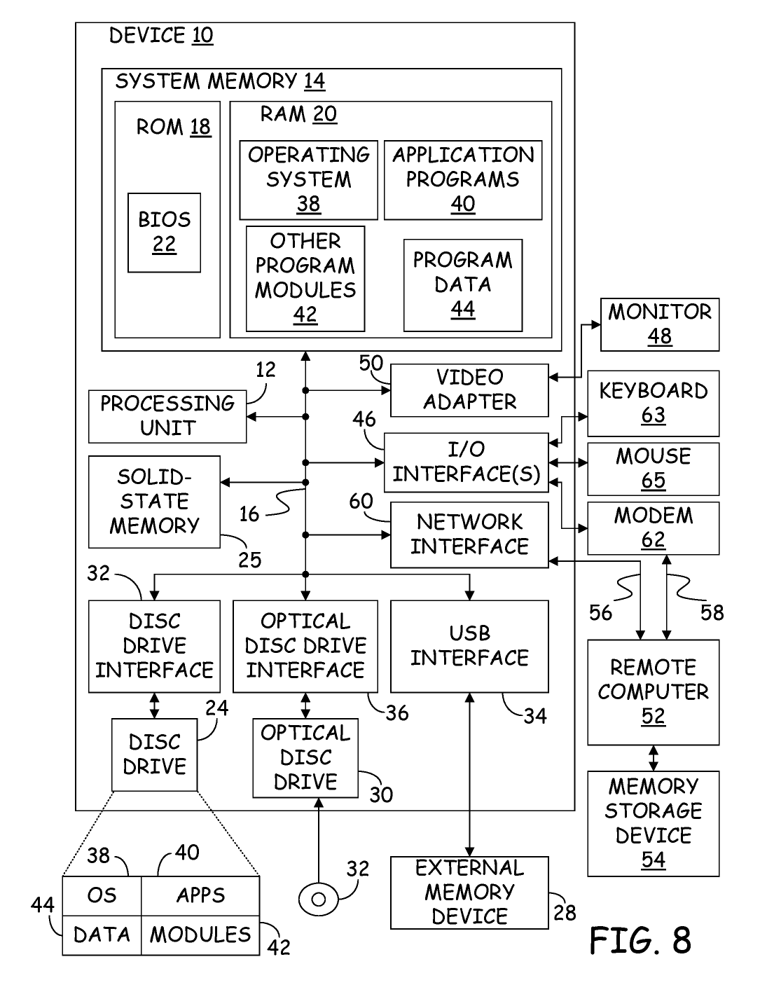

FIG. 8 provides an example of a computing device 10 that can be used as a server device or mobile device in the embodiments above. Computing device 10 includes a processing unit 12, a system memory 14 and a system bus 16 that couples the system memory 14 to the processing unit 12. System memory 14 includes read only memory (ROM) 18 and random access memory (RAM) 20. A basic input/output system 22 (BIOS), containing the basic routines that help to transfer information between elements within the computing device 10, is stored in ROM 18. Computer-executable instructions that are to be executed by processing unit 12 may be stored in random access memory 20 before being executed.

Those skilled in the art will also appreciate that embodiments can also be applied within computer systems wherein tasks are performed by remote processing devices that are linked through a communications network (e.g., communication utilizing Internet or web-based software systems). For example, program modules may be located in either local or remote memory storage devices or simultaneously in both local and remote memory storage devices. Similarly, any storage of data associated with embodiments of the present invention may be accomplished utilizing either local or remote storage devices, or simultaneously utilizing both local and remote storage devices.

Computing device 10 further includes an optional hard disc drive 24, an optional external memory device 28, and an optional optical disc drive 30. External memory device 28 can include an external disc drive or solid state memory that may be attached to computing device 10 through an interface such as Universal Serial Bus interface 34, which is connected to system bus 16. Optical disc drive 30 can illustratively be utilized for reading data from (or writing data to) optical media, such as a CD-ROM disc 32. Hard disc drive 24 and optical disc drive 30 are connected to the system bus 16 by a hard disc drive interface 32 and an optical disc drive interface 36, respectively. The drives and external memory devices and their associated computer-readable media provide nonvolatile storage media for the computing device 10 on which computer-executable instructions and computer-readable data structures may be stored. Other types of media that are readable by a computer may also be used in the exemplary operation environment.

A number of program modules may be stored in the drives and RAM 20, including an operating system 38, one or more application programs 40, other program modules 42 and program data 44. In particular, application programs 40 can include programs for implementing any one of search process 208, session logger 214, metrics calculator 218, search term metrics process 226, and search rules process 230. Program data 44 may include data such as data in search rules database 212, product attributes database 210, session logs 216, metrics database 220, graph user interface 231, metrics user interface 228, footprint user interface 229, search rules user interface 232 and webpages 206, for example.

Processing unit 12, also referred to as a processor, executes programs in system memory 14 and solid state memory 25 to perform the methods described above.

Input devices including a keyboard 63 and a mouse 65 are optionally connected to system bus 16 through an Input/Output interface 46 that is coupled to system bus 16. Monitor or display 48 is connected to the system bus 16 through a video adapter 50 and provides graphical images to users. Other peripheral output devices (e.g., speakers or printers) could also be included but have not been illustrated. In accordance with some embodiments, monitor 48 comprises a touch screen that both displays input and provides locations on the screen where the user is contacting the screen.

The computing device 10 may operate in a network environment utilizing connections to one or more remote computers, such as a remote computer 52. The remote computer 52 may be a server, a router, a peer device, or other common network node. Remote computer 52 may include many or all of the features and elements described in relation to computing device 10, although only a memory storage device 54 has been illustrated in FIG. 8. The network connections depicted in FIG. 8 include a local area network (LAN) 56 and a wide area network (WAN) 58. Such network environments are commonplace in the art.

The computing device 10 is connected to the LAN 56 through a network interface 60. The computing device 10 is also connected to WAN 58 and includes a modem 62 for establishing communications over the WAN 58. The modem 62, which may be internal or external, is connected to the system bus 16 via the I/O interface 46. Order 206 is received through either network interface 60 or modem 62.

In a networked environment, program modules depicted relative to the computing device 10, or portions thereof, may be stored in the remote memory storage device 54. For example, application programs may be stored utilizing memory storage device 54. In addition, data associated with an application program may illustratively be stored within memory storage device 54. It will be appreciated that the network connections shown in FIG. 8 are exemplary and other means for establishing a communications link between the computers, such as a wireless interface communications link, may be used.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms for implementing the claims.

What is claimed is:

1. A computer-implemented method comprising:
receiving, by a server, a term;
searching, by the server, a database to identify consumer searches of a website that included the term;
for each identified consumer search, retrieving metrics related to visits to the website during which the consumer search was submitted, the metrics including metrics related to purchases;
displaying a user interface showing the metrics for a plurality of the identified consumer searches;
receiving a rule definition for one of the identified consumer searches, the rule definition indicating a web page that is to be returned; and
linking the rule definition to the one identified consumer search in a search rules database used by a web server that serves the website such that when the consumer search is submitted the web server returns the web page.

2. The computer-implemented method of claim 1 wherein displaying the user interface showing metrics for the identified consumer searches comprises displaying a plurality of metrics for each identified consumer search, and displaying a plurality of combined metrics, wherein each combined metric is formed by combining metrics from the identified consumer searches.

3. The computer-implemented method of claim 2 wherein displaying a plurality of metrics for each identified consumer search comprises displaying a metric indicating that one of the identified consumer searches results in lower purchases than other identified consumer searches and receiving the rule definition comprises receiving a rule definition for the identified consumer search that resulted in lower purchases.

4. The computer-implemented method of claim 3 wherein displaying a plurality of metrics for each identified consumer search comprises displaying a conversion percentage for each identified consumer search and wherein displaying a plurality of combined metrics comprises displaying an average conversion percentage for the identified consumer searches.

5. The computer-implemented method of claim 1 wherein displaying the user interface showing the metrics of the identified consumer searches comprises displaying a date control that can be altered to select a range of dates for the metrics.

6. The computer-implemented method of claim 5 wherein displaying the user interface showing the metrics of the identified consumer searches comprises displaying a graph control for one of the metrics such that when the graph control is selected, a graph showing values of the metric on a plurality of different dates is shown.

7. The computer-implemented method of claim 1 wherein displaying the user interface showing the metrics of the identified consumer searches comprises displaying a link for each identified consumer search such that when a respective link is selected, a page for the identified consumer search associated with the link is displayed, the page providing at least one selectable control for setting a rule definition for the associated identified consumer search.

8. A server comprising:
a memory storing actual search phrases submitted to a retail web site by customers, and for each actual search phrase, a value for at least one web site session metric; and
a processor, the processor executing processes to:
receive a term through a user interface;
search the memory to identify all actual search phrases that include the term;
for each identified actual search phrase, retrieve the value for the at least one session metric for the actual search phrase; and
generate a user interface that includes each identified actual search phrase and the value for the at least one session metric for each identified actual search phrase such that the values for the at least one session metric for two separately identified actual search phrases are displayed at the same time.

9. The server of claim 8 wherein the at least one session metric comprises a site rank, wherein the value of the site rank for an identified actual search phrase comprises a rank of the identified actual search phrase relative to all other actual search phrases during a time period.

10. The server of claim 8 wherein the processor further retrieves a combined value for the at least one session metric, the combined value formed by combining the values of the at least one session metric for the identified actual search phrases and wherein the user interface generated by the processor further displays the combined value for the at least one session metric.

11. The server of claim 10 wherein for each identified actual search phrase, the value of the at least one session metric comprises a number of sessions during which the identified actual search phrase was received and the combined value for the at least one session metric comprises the sum of the number of sessions during which the identified actual search phrases were received.

12. The server of claim 8 further comprising receiving a date range and using the date range to limit the search for actual search phrases to actual search phrases that included the term and were submitted during a session that took place within the date range.

13. The server of claim 12 wherein generating a user interface comprises including a control to change the date range such that when the control is used to change the date range to a new date range, the steps of searching for actual search phrases, retrieving the value for the at least one session metric and generating the user interface are repeated for the new date range.

14. The server of claim 8 wherein generating the user interface comprises generating a link for each identified actual search phrase, each link such that when the link is selected, a page for the identified actual search phrase associated with the link is displayed, the page providing at least one selectable control for setting a rule definition for the associated identified actual search phrase to control what page is returned when the actual search phrase is received.

15. A method comprising:
displaying a user interface that includes a date range control and a term input area;
receiving a date range through the date range control and a term through the term input area;
retrieving metrics for all search phrases that were submitted to a web site during the date range and that included the term;
displaying the retrieved metrics such that retrieved metrics for a plurality of search phrases are shown together.

16. The method of claim 15 wherein displaying the retrieved metrics comprises displaying the date range control and wherein the method further comprises:
receiving a new date range through the date range control;
retrieving new metrics for all search phrases that were submitted to the web site during the new date range and that included the term;
displaying the retrieved new metrics such that retrieved new metrics for a plurality of search phrases are shown together.

17. The method of claim 15 wherein the metrics comprise combined metrics that are formed by combining individual metrics for the search phrases that were submitted to the web site during the date range and that included the term.

18. The method of claim 15 wherein the metrics comprises an amount purchased from the web site during a session in which the search phrase was submitted to the web site.

19. The method of claim 15 wherein displaying the retrieved metrics comprises displaying a link for each search phrase to a respective page that provides metrics for only the respective search phrase.

20. The method of claim 19 wherein the respective page comprises a link for setting a rule to be used when the web site receives the respective search phrase.
